(19) United States
(12) Patent Application Publication
(10) Pub. No.: US 2014/0273183 A1
(43) Pub. Date: Sep. 18, 2014

(54) SUBSTRATE DETECTION DEVICE AND BIOFUEL CELL WITH SUBSTRATE DETECTION FUNCTION

(71) Applicant: Sony Corporation, Tokyo (JP)

(72) Inventors: Daisuke YAMAGUCHI, Kanagawa (JP); Yoshiaki INOUE, Aichi (JP); Tsunetoshi SAMUKAWA, Kanagawa (JP); Taiki SUGIYAMA, Kanagawa (JP); Jusuke SHIMURA, Kanagawa (JP)

(73) Assignee: Sony Corporation, Tokyo (JP)

(21) Appl. No.: 14/195,254

(22) Filed: Mar. 3, 2014

(30) Foreign Application Priority Data
Mar. 14, 2013 (JP) 2013-051430

(51) Int. Cl. G01N 27/26

(52) U.S. Cl. CPC G01N 27/26
USPC 435/287.1

(57) ABSTRACT

There is provided a substrate detection device including a sensor unit configured to extract electrons by oxidizing a substrate, the substrate being a test target, a capacitor connected in series to the sensor unit, and a circuit configured to measure a voltage across terminals of the capacitor. The substrate detection device determines a concentration of the substrate based on the voltage across the terminals of the capacitor.

### CROSS REFERENCES TO RELATED APPLICATIONS

The present application claims priority to Japanese Priority Patent Application JP 2013-051430 filed in the Japan Patent Office on Mar. 14, 2013, the entire content of which is hereby incorporated by reference.

### BACKGROUND

The present disclosure relates to a substrate detection device and a biofuel cell with a substrate detection function. More specifically, the present disclosure relates to a preferred substrate detection device that is applied in determining the concentration of various kinds of substrate in liquids, and a biofuel cell with a substrate detection function in which a substrate detection device is integrated in a biofuel cell that uses a glucose solution as a fuel.

Compact urine sugar measurement devices and blood sugar self-monitoring devices have been commercially available in the past (e.g., refer to JP 2007-532266T). The power consumption of most of these urine sugar measurement devices or blood sugar self-monitoring devices is about 18 mW (including a 6 mA/3V/LCD) to 100 mW. These urine sugar measurement devices or blood sugar self-monitoring devices, which use a compact button battery, such as the coin type lithium battery CR2032, are capable of performing measurement about 1,000 times.

### SUMMARY

However, previous urine sugar measurement and blood sugar self-monitoring commercial products have had a high cost.

Accordingly, it is desirable to provide a substrate detection device that is capable of determining the concentration of sugars, including glucose, or various kinds of substrate, and that also has a circuit configuration that can be produced simply and inexpensively.

Further, it is also desirable to provide a biofuel cell with a substrate detection function that has a function of determining the concentration of a substrate included in the fuel of the biofuel cell.

These and other points will become clear based on the following descriptions in the present specification with reference to the attached drawings.

According to an embodiment of the present disclosure, there is provided a substrate detection device which includes

a sensor unit configured to extract electrons by oxidizing a substrate, which is a test target,

a capacitor connected in series to the sensor unit, and a circuit for measuring a voltage across terminals of the capacitor,

wherein the substrate detection device determines a concentration of the substrate based on the voltage across the terminals of the capacitor.

This substrate detection device further has, for example, a power supply, a constant voltage generation circuit that is supplied with a voltage from the power supply, and a sensor unit constant voltage application circuit for applying the constant voltage generated by the constant voltage generation circuit to the sensor unit. Typically, this substrate detection device also has at least one comparison circuit into which a voltage across the capacitor terminals is input. The resolution performance of the determination of the substrate concentration can be adjusted by selecting the number of comparison circuits. This substrate detection device preferably further has an operational amplifier into which a voltage across the capacitor terminals is input. The output voltage of this operational amplifier is input into the comparison circuit and compared with a reference voltage. This reference voltage is selected based on a desired substrate concentration. The constant voltage generation circuit has, for example, a first DC/DC converter that reduces the voltage of the power supply. Further, the sensor unit constant voltage application circuit has, for example, a second DC/DC converter, which has a feedback terminal, that reduces the voltage that was reduced by the first DC/DC converter. The sensor unit is connected to the feedback terminal of this second DC/DC converter, and preferably the sensor unit is connected via a fixed resistor. The voltage applied to the sensor unit can be adjusted to an arbitrary value by adjusting the resistance value of this fixed resistor. This substrate detection device also typically has a display unit that is supplied with an output voltage of the comparison circuit. The configuration of the display unit and the content and the like that is displayed may be selected as appropriate. For example, content indicating the detected substrate concentration may be displayed. The sensor unit includes an enzyme or a microorganism that oxidizes the substrate. The enzyme or microorganism may be selected as appropriate based on the substrate from among known enzymes or microorganisms. In addition to the enzyme or microorganism that oxidizes the substrate, the sensor unit may optionally include an electron mediator for transferring the electrons produced by the oxidation of the substrate to the sensor unit. Examples of microorganisms that can be used include, but are not especially limited to, various types of microorganisms known in the related art, such as bacteria belonging to the genera Saccharomyces, Hansenula, Candida, Micrococcus, Staphylococcus and the like, filamentous bacteria, and yeasts, as well as microorganisms produced by genetic engineering and the like. The substrate detected by this substrate detection device is typically included in a liquid. Although the substrate may basically be anything, examples include at least one kind selected from the group consisting of glucose, bile acid, pyruvic acid, dissolved oxygen, formaldehyde, and carbon monoxide.

According to an embodiment of the present disclosure, there is provided a biofuel cell with a substrate detection function, including

a biofuel cell configured to generate electricity by extracting electrons by oxidizing a substrate included in a fuel solution, and

a substrate detection device integrally provided with the biofuel cell,

wherein the substrate detection device includes
a sensor unit configured to extract electrons by oxidizing a substrate, the substrate being a test target,
a capacitor connected in series to the sensor unit, and
a circuit configured to measure a voltage across terminals of the capacitor, and

wherein the substrate detection device determines a concentration of the substrate based on the voltage across the terminals of the capacitor.

The biofuel cell with a substrate detection function according to an embodiment of the present disclosure may include the above-described substrate detection device, as long as this device does not run counter to the nature of the biofuel cell. Although the details of the biofuel cell are described in, for example, JP 2000-133297A, JP 2003-282124, JP 2004-71559A, JP 2005-13210A, JP 2005-310613A, JP 2006-24555A, JP 2006-49215A, JP 2006-93090A, JP 2006-127957A, JP 2006-156354A, JP 2007-12281A, and JP 2007-35437A, an outline will be described below.

The biofuel cell has a positive electrode, a negative electrode, and a proton conductor arranged between the positive electrode and the negative electrode. An enzyme is immobilized on the positive electrode and the negative electrode. The overall configuration of the biofuel cell is typically in a thin sheet-like form by configuring each of the positive electrode, the negative electrode, and the proton conductor in a thin sheet shape. The enzyme immobilized on the negative electrode typically includes an oxidase that decomposes a fuel, such as glucose, by promoting oxidation of the fuel. Further, this enzyme also typically includes a coenzyme oxidase that returns a coenzyme reduced during oxidation of the fuel back into an oxidant, and transfers electrons to the negative electrode via the electron mediator. Specifically, the enzyme immobilized on the negative electrode preferably includes an oxidase that decomposes the fuel, such as glucose, by promoting oxidation of the fuel and a coenzyme oxidase that returns the coenzyme that is reduced by this oxidase back into an oxidant. Due to the action of this coenzyme oxidase, electrons are produced when the coenzyme is turned back into an oxidant, and the electrons are transferred from the coenzyme oxidase to the negative electrode via the electron mediator. For example, if glucose is used as the fuel, glucose dehydrogenase (GDH) (in particular, NAD-dependent glucose dehydrogenase), for example, is used as the oxidase, NAD⁺, or NADP⁺, for example, is used as the coenzyme, and diaphorase (DI), for example, is used as the coenzyme oxidase.

Although basically anything can be used as the electron mediator, preferably, a compound having a quinone skeleton is used. Specifically, for example, 2,3-dimethoxy-5-methyl-1,4-benzoquinone (Q0), or a compound having a naphthoquinone skeleton, for example, various kinds of naphthoquinone derivative, such as 2-amino-1,4-naphthoquinone (ANQ), 2-amino-3-methyl-1,4-naphthoquinone (AMNQ), 2-methyl-1,4-naphthoquinone (VK3), 2-amino-3-carboxy-1,4-naphthoquinone (ACNQ), and vitamin K1, is used. As the compound having a quinone skeleton, for example, anthraquinone or a derivative thereof can be used. In addition to the compound having a quinone skeleton, the electron mediator may optionally also include one kind or two or more kinds of other compound that act as an electron mediator. This electron mediator may be immobilized on the negative electrode along with a ribosome that includes an enzyme and a coenzyme, or may be included in this ribosome, or may be immobilized on this ribosome, or may be included in a fuel solution.

The enzyme immobilized on the positive electrode typically includes an enzyme that reduces oxygen. Examples of this oxygen-reducing enzyme include bilirubin oxidase, laccase, ascorbic acid oxidase and the like. In this case, preferably, in addition to the enzyme, an electron mediator is also immobilized on the positive electrode. As the electron mediator, for example, potassium hexacyanoferrate, potassium ferricyanide, potassium octacyanotungstate and the like is used. Preferably, the electron mediator is immobilized at a sufficiently high concentration, for example, 0.64×10⁻⁶ mol/mm² or more on average.

As for the proton conductor, various substances can be used and selected as appropriate. Specific examples thereof include substances formed from cellophane, perfluorocarbon sulfonic acid (PFS)-based resin films, copolymer films of trifluorostyrene derivatives, phosphoric acid-impregnated polybenzimidazole films, aromatic polyether ketone sulfonic acid films, PSSA-PVA (polystyrene sulfonic acid-polyvinyl alcohol copolymers), PSSA-EVOH (polystyrene sulfonic acid-ethylene vinyl alcohol copolymers), and ion exchange resins having a fluorine-containing carbon sulfonic acid group (Nafion (trade name, DuPont, USA)) and the like.

When using an electrolyte including a buffer solution (buffering substance) as the proton conductor, it is desirable to design the buffer so that a sufficient buffering performance can be obtained during a high output operation, and so that the enzyme can sufficiently exhibit its inherent capabilities. Consequently, it is effective if the concentration of the buffering substance included in the electrolyte is 0.2 M or more to 2.5 M or less, and preferably 0.2 M or more to 2 M or less, more preferably 0.4 M or more to 2 M or less, and even more preferably 0.8 M or more to 1.2 M or less. Generally, although any buffering substance having a pKa of 6 or more to 9 or less can be used, specific examples of the buffering substance include dihydrogen phosphate ions (H2PO4⁻), 2-amino-2-hydroxymethyl-1,3-propanediol (abbreviated as Tris), 2-(N-morpholino)ethanesulfonic acid (MES), cacodylic acid, carbonic acid (H₂CO₃), hydrogen citrate ions, N-(2-acetamido)iminodiacetic acid (ADA), piperazine-N,N′-bis(2-ethanesulfonic acid) (PIPES), N-(2-acetamido)-2-aminoethanesulfonic acid (ACES), 3-(N-morpholino)propanesulfonic acid (MOPS), N-2-hydroxyethylpiperazine-N′-2-ethanesulfonic acid (HEPES), N-2-hydroxyethylpiperazine-N′-3-propanesulfonic acid (HEPPS), N-[tris(hydroxymethyl)methyl]glycine (abbreviated as Tricine), glycylglycine, and N,N-bis(2-hydroxyethyl)glycine (abbreviated as Bicine). The dihydrogen phosphate ions (H₂PO₄⁻) may be produced from, for example, substances such as sodium dihydrogen phosphate (NaH₂PO₄) and potassium dihydrogen phosphate (KH₂PO₄). A compound including an imidazole ring is preferred as the buffering substance. Specific examples of compounds including an imidazole ring include imidazole, triazole, pyridine derivatives, bipyridine derivatives, and imidazole derivatives (histidine, 1-methylimidazole, 2-methylimidazole, 4-methylimidazole, 2-ethylimidazole, ethyl imidazole-2-carboxylate, imidazole-2-carboxaldehyde, imidazole-4-carboxylic acid, imidazole-4,5-dicarboxylic acid, imidazol-1-yl-acetic acid, 2-acetylbenzimidazole, 1-acetylimidazole, N-acetylimidazole, 2-aminobenzimidazole, N-(3-aminopropyl)imidazole, 5-amino-2-(trifluoromethyl)benzimidazole, 4-azabenzimidazole, 4-aza-2-mercaptobenzimidazole, benzimidazole, 1-benzylimidazole, and 1-butylimidazole etc.). In addition to these buffering substances, at least one kind of substance selected from the group consisting of, for example, hydrochloric acid (HCl), acetic acid (CH₃COOH), phosphoric acid (H₃PO₄), and sulfuric acid (H₂SO₄) may optionally be added as a neutralizing agent. By adding such a neutralizing agent, the activity of the enzyme can be maintained at a higher level. Although the pH of the electrolyte including the buffering substance is preferably around 7, the pH may be anywhere between 1 and 14.

Although various electrode materials can be used for the positive electrode and the negative electrode, examples thereof include carbonaceous materials, such as porous carbon, carbon pellets, carbon felt, and carbon paper. As the electrode material, a porous conductive material that includes as its main components a skeleton formed from a porous material and a carbonaceous material that covers at least a part of this skeleton may be used (refer to JP 2007-35437A).

As the fuel, various substances may be selected and used as appropriate. Examples of fuels other than glucose include various organic acids that are involved in the citric acid cycle, and sugars and organic acids that are involved in the pentose phosphate cycle. Examples of various organic acids involved in the citric acid cycle include lactic acid, pyruvic acid, acetyl-CoA, citric acid, isocitric acid, α-ketoglutarate, succinyl-CoA, succinic acid, fumaric acid, malic acid, oxaloacetic and the like. Examples of sugars and organic acids that are involved in the pentose phosphate cycle include glucose-6-phosphate, 6-phosphogluconolactone, 6-phosphogluconic acid, ribulose-5-phosphate, glyceryl aldehyde 3-phosphate, fructose 6-phosphate, xylilose 5-phosphate, sedoheptulose 7-phosphate, erythrose 4-phosphate, phosphoenolpyruvic acid, 1,3-bisphosphoglyceric acid, ribose 5-phosphate, and the like. As the fuel, an alcohol, such as methanol and ethanol, may be used. These fuels are typically used in the form of a fuel solution in which the fuel is dissolved in a buffer solution known in the related art, such as a phosphate buffer, a tris buffer solution and the like.

Thus, in the present disclosure, a substrate detection device can be configured with a simple circuit configuration. Consequently, production of the substrate detection device is simple, so that production costs can be reduced. Further, by connecting a second DC/DC converter feedback terminal to the sensor unit, the voltage applied to the sensor unit can be set at a fixed level. In addition, during use the concentration of a substrate in the fuel solution can be determined by a biofuel cell with a substrate detection function in which this substrate detection device is integrated in the biofuel cell.

According to one or more of embodiments of the present disclosure, a substrate detection device can be obtained that is capable of determining the concentration of a sugar, including glucose, or of various kinds of substrate, and yet whose circuit configuration can be produced simply and inexpensively. Further, the concentration of a substrate included in the fuel solution of a biofuel cell can be determined with a biofuel cell with a substrate detection function in which this excellent substrate detection device is integrated in the biofuel cell.

Additional features and advantages are described herein, and will be apparent from the following Detailed Description and the figures.

### BRIEF DESCRIPTION OF THE FIGURES

FIG. 1 is a circuit block diagram of a substrate detection device according to a first embodiment of the present disclosure;

FIG. 2 is a circuit block diagram illustrating a specific configuration example of a substrate detection device according to the first embodiment of the present disclosure;

FIG. 3 is a circuit block diagram illustrating a state when a voltage is applied to a sensor in the substrate detection device illustrated in FIG. 2;

FIG. 4 is a circuit block diagram illustrating a state when reading the voltage across the electrodes of a capacitor in the substrate detection device illustrated in FIG. 2;

FIG. 5 is a circuit block diagram illustrating a configuration in which a timer IC is connected to the substrate detection device illustrated in FIG. 2;

FIG. 6 is a circuit block diagram illustrating a specific example of a display unit in the substrate detection device illustrated in FIG. 2;

FIG. 7 is a circuit diagram illustrating operation of a DC/DC converter provided with a feedback terminal in the substrate detection device illustrated in FIG. 2;

FIG. 8 is a circuit diagram illustrating a specific example of a DC/DC converter provided with a feedback terminal;

FIG. 9 is a diagram illustrating operation of a DC/DC converter provided with a feedback terminal;

FIG. 10 is a circuit diagram illustrating operation of a DC/DC converter provided with a feedback terminal;

FIG. 11 is a circuit diagram illustrating operation of a DC/DC converter provided with a feedback terminal;

FIG. 12 is a circuit diagram illustrating operation of a DC/DC converter provided with a feedback terminal;

FIG. 13 is a circuit diagram illustrating operation of a sensor strip in the substrate detection device illustrated in FIG. 2;

FIG. 14 is a diagram illustrating the relationship between a sensor current and a voltage across the terminals of a capacitor C1 in the substrate detection device illustrated in FIG. 2;

FIG. 15 is a diagram illustrating another example of the relationship between a sensor current and a voltage across the terminals of a capacitor C1 in the substrate detection device illustrated in FIG. 2;

FIG. 16 is a diagram illustrating yet another example of the relationship between a sensor current and a voltage across the terminals of a capacitor C1 in the substrate detection device illustrated in FIG. 2;

FIG. 17 is a diagram illustrating a voltage applied to a sensor strip in the substrate detection device illustrated in FIG. 2;

FIG. 18 is a diagram illustrating the effect obtained by a DC/DC converter 30 in the substrate detection device illustrated in FIG. 2;

FIG. 19 is a diagram illustrating the effect obtained by a DC/DC converter 30 in the substrate detection device illustrated in FIG. 2;

FIG. 20 is a diagram illustrating the effect obtained by a DC/DC converter 30 in the substrate detection device illustrated in FIG. 2;

FIG. 21 is a diagram illustrating the effect obtained by a DC/DC converter 30 in the substrate detection device illustrated in FIG. 2;

FIG. 22 is a diagram illustrating a circuit having a plurality of comparators in the substrate detection device illustrated in FIG. 2;

FIG. 23 is a diagram illustrating the results of an experiment to measure the glucose concentration of glucose solutions using a substrate detection device in Example 1;

FIG. 24 is a diagram illustrating the results of an experiment to measure the glucose concentration of glucose solutions using a substrate detection device in Example 1;

FIG. 25 is a diagram illustrating the results of an experiment to measure the glucose concentration of glucose solutions using a substrate detection device in Example 1;

FIG. 26 is a diagram illustrating the results of an experiment to measure the glucose concentration of glucose solutions using a substrate detection device in Example 1;

FIG. 27 is a diagram illustrating the voltage across the capacitor terminals and the voltage drop obtained from the measurement results illustrated in FIGS. 23 to 26;

FIG. 28 is a diagram illustrating the results of an experiment performed in Example 2 in order to prove the effects obtained by the DC/DC converter 30 in the substrate detection device illustrated in FIG. 2;

FIG. 29 is a diagram illustrating a method for detecting bile acid using the substrate detection device according to the first embodiment of the present disclosure as a bile acid sensor;

FIG. 30 is a diagram illustrating a method for detecting pyruvic acid using the substrate detection device according to the first embodiment of the present disclosure as a pyruvic acid sensor;

FIG. 31 is a diagram illustrating a method for detecting dissolved oxygen using the substrate detection device according to the first embodiment of the present disclosure as a dissolved oxygen sensor;

FIG. 32 is a diagram illustrating a method for detecting formaldehyde using the substrate detection device according to the first embodiment of the present disclosure as a formaldehyde sensor;

FIG. 33 is a diagram illustrating a biofuel cell with a substrate detection function according to a second embodiment of the present disclosure;

FIG. 34 is a diagram illustrating a method for housing a biofuel cell with a substrate detection function according to the second embodiment of the present disclosure in a case;

FIG. 35 is a diagram illustrating a function of displaying a substrate concentration on a case housing a biofuel cell with a substrate detection function according to the second embodiment of the present disclosure;

FIG. 36 is a diagram illustrating a method for transmitting a substrate concentration of a biofuel cell with a substrate detection function according to the second embodiment of the present disclosure by telecommunication;

FIG. 37 is a diagram illustrating a method for transmitting a substrate concentration of a biofuel cell with a substrate detection function according to the second embodiment of the present disclosure by telecommunication.

FIG. 38 is a diagram illustrating a method for transmitting a substrate concentration of a biofuel cell with a substrate detection function according to the second embodiment of the present disclosure by telecommunication;

FIG. 39 is a diagram illustrating principles of a fuel capsule for a biofuel cell;

FIG. 40 is a diagram illustrating principles of a fuel capsule for a biofuel cell; and

FIG. 41 is a diagram illustrating principles of a fuel capsule for a biofuel cell.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted. It is noted that description will be made in the following order.

1. First embodiment of the present disclosure (substrate detection device)
2. Second embodiment of the present disclosure (biofuel cell with a substrate detection function)

### 1. First Embodiment of the Present Disclosure

### Substrate Detection Device

FIG. 1 illustrates a substrate detection device according to the first embodiment of the present disclosure.

As illustrated in FIG. 1, the substrate detection device has a power supply 11, a constant voltage generation circuit 12, a sensor strip constant voltage application circuit 13, a capacitor (condenser) 14, a sensor strip 15, a comparison circuit 16, and a display unit 17. The sensor strip 15 includes at least one kind of enzyme or microbe that oxidizes a substrate, which is a test target. This enzyme or microbe is preferably immobilized on the substrate by an immobilization technology known in the related art. A direct current power supply voltage is supplied from the power supply 11 to the constant voltage generation circuit 12. A constant voltage generated by the constant voltage generation circuit 12 is supplied to the sensor strip constant voltage application circuit 13. A voltage Vᵢₙ+voltage Vₛₑₙₛ, which is the sum of a voltage Vᵢₙ across the terminals of the capacitor 14 and a voltage Vₛₑₙₛ applied to the sensor strip 15, is applied to one of the terminals of the capacitor 14 by the sensor strip constant voltage application circuit 13. The voltage Vₛₑₙₛ is applied to the sensor strip 15 by the capacitor 14. The voltage Vₛₑₙₛ applied to the sensor strip 15 is sent as feedback to the sensor strip constant voltage application circuit 13. The voltage Vᵢₙ across the terminals of the capacitor 14 is a voltage that reflects the accumulated electric charge, or in other words the concentration of the substrate in the liquid of the detection target, due to the accumulation in the capacitor 14 of the electrons produced by the oxidation of the substrate, which is the test target, by the enzyme or microbe of the sensor strip 15. Namely, the concentration of the substrate, which is the test target, in the liquid can be determined based on the voltage Vᵢₙ across the terminals of the capacitor 14. The voltage Vᵢₙ across the terminals of the capacitor 14 is input to the comparison circuit 16. At the comparison circuit 16, a comparison is performed between the input voltage Vᵢₙ and a reference voltage V_{ref} that has been preset based on the concentration of the substrate. A voltage Vₒᵤₜ based on this result is output from the comparison circuit 16. The output voltage Vₒᵤₜ from the comparison circuit 16 is supplied to the display unit 17. At the display unit 17, a display reflecting the voltage Vᵢₙ, namely, the concentration of the substrate, is performed. The power supply 11 is not especially limited. For example, the power supply 11, which is selected as appropriate, may be a primary battery, a secondary battery, a fuel cell (a biofuel cell or some other kind of fuel cell), a solar cell and the like.

FIG. 2 illustrates a specific configuration example of this substrate detection device.

As illustrated in FIG. 2, a battery 21 having a voltage value of V_{cc} is used as the power supply 11. The negative electrode of the battery 21 is grounded. The positive electrode of the battery 21 is connected via a switch 22 to an input terminal 23a of a DC/DC converter 23 serving as the constant voltage generation circuit 12. The DC/DC converter 23 has a function of reducing (down converting) the voltage V_{cc} of the battery 21 to a voltage V_{DD}. This step-down value V_{DD} can be determined by a fixed resistor (not illustrated) connected to the DC/DC converter 23. The DC/DC converter 23 may basically be any converter, and is selected as appropriate.

The step-down value V_{DD} output from an output terminal 23b of the DC/DC converter 23 is supplied to two input terminals of a multiplexer 24. The multiplexer 24 has switches 25 and 26 connected to the two input terminals. The output terminal of the switches 25 and 26 are connected to power supply lines 27 and 28 that supply the V_{DD}. The selection of power supply line 27 or 28 is made by switching the switches 25 and 26. The power supply line 27 is connected to a display unit 29. The power supply line 27 is also grounded via resistors R1 and R2 connected in series. The power supply line 28 is connected to an input terminal 30a of a DC/DC converter 30. An output terminal 30b of the DC/DC converter 30 is connected to an input terminal of a multiplexer 31. The multiplexer 31 has two switches 32 and 33 connected in series. The DC/DC converter 30 has a feedback (FB) terminal 30c. This feedback terminal 30c is connected to one terminal of a sensor strip Rₛₑₙₛ via a fixed resistor R3, and is grounded via a fixed resistor R4. Further, the other terminal of the sensor strip Rₛₑₙₛ is grounded. Vₛₑₙₛ represents the applied voltage to the sensor strip Rₛₑₙₛ. The voltage Vₛₑₙₛ can be adjusted to an arbitrary value by adjusting the value of the resistor R3. The DC/DC converter 30 includes a feedback mechanism for maintaining a voltage V_{FB} of the feedback terminal 30c at a fixed level, which enables the voltage Vₛₑₙₛ to be maintained at a fixed value. The DC/DC converter 30 and the fixed resistors R3 and R4 configure the sensor strip constant voltage application circuit 13.

A line 34 connecting switches 32 and 33 of the multiplexer 31 is connected to one terminal of a capacitor C1. The other terminal of the capacitor C1 is connected to switches 36 and 37 of a multiplexer 35. The switch 36 is connected to both the fixed resistor R3 and to the sensor strip Rₛₑₙₛ. One terminal of the switch 37 is grounded.

The switch 33 of the multiplexer 31 is connected to a non-inverting input terminal of an operational amplifier 38. The voltage Vᵢₙ across the terminals of the capacitor C1 is input to this non-inverting input terminal. The electrons flowing due to the application of the voltage Vₛₑₙₛ to the sensor strip Rₛₑₙₛ accumulate in the capacitor C1. Vᵢₙ increases based on the current value and the time to an upper limit of V_{DD}−Vₛₑₙₛ. An inverting input terminal of the operational amplifier 38 is connected to an output terminal of the operational amplifier 38, and configures a voltage follower. The voltage V_{DD} supplied by the power supply line 27 is divided by fixed resistors R1 and R2 connected in series to a line 39 that branches from the power supply line 27, so that a voltage R2/(R1+R2)/V_{DD} is input to a non-inverting input terminal of a comparator 40. This voltage R2/(R1+R2)/V_{DD} serves as the reference voltage V_{ref} of the comparator 40. An arbitrary reference voltage V_{ref} that is based on the concentration of the substrate to be determined can be adjusted based on the resistance value of the fixed resistors R1 and R2. An inverting input terminal of the comparator 40 is connected to an output terminal of the operational amplifier 38. Based on the voltage value Vᵢₙ of a signal input to an inverting input terminal of the comparator 40, if Vᵢₙ exceeds V_{ref}, the output of the comparator 40 changes to a negative direction. If V_{ref} is an inverting input and Vᵢₙ is a non-inverting input, when Vᵢₙ exceeds V_{ref}, the output of the comparator 40 changes to a positive direction. Although the selection about which voltage to input for the inverting input and the non-inverting input of the comparator 40 is determined based on how the comparison result output from the comparator 40 is processed as an electronic circuit, in the circuit illustrated in FIG. 2, as described above, V_{ref} is an inverting input and Vᵢₙ is a non-inverting input, so that when Vᵢₙ exceeds V_{ref}, the output of the comparator 40 changes to a negative direction. The output voltage Vₒᵤₜ from the output terminal of the comparator 40 can be reflected on the display unit 29. As the display unit 29, for example, a light-emitting diode (LED), a liquid crystal display (LCD), an organic electroluminescence (EL) display and the like may be used. Leak current from the capacitor C1 can be suppressed and the input voltage to the comparator 40 can be maintained by the voltage follower using the operational amplifier 38 and the multiplexers 24, 31, and 35. Switching among the multiplexers 24, 31, and 35 can be controlled using a timer IC, such as a multivibrator.

FIG. 3 illustrates the substrate detection device when the voltage Vₛₑₙₛ is applied to the sensor strip Rₛₑₙₛ. As illustrated in FIG. 3, at this point, the switches 22, 26, 32, and 36 are ON, and the switches 25, 33, and 37 are OFF. By applying the voltage Vₛₑₙₛ to the sensor strip Rₛₑₙₛ, the substrate is oxidized by the enzyme or microbe of the sensor strip Rₛₑₙₛ, and the electrons produced by this oxidation accumulate in the capacitor C1, so that the voltage Vᵢₙ across the terminals of the capacitor C1 increases.

FIG. 4 illustrates the substrate detection device during reading of the voltage Vᵢₙ across the terminals of the capacitor C1 that has been thus increased based on the concentration of the substrate. As illustrated in FIG. 4, at this point, the switches 22, 25, 33, and 37 are ON, and the switches 26, 32, and 36 are OFF. Thus, during reading of the voltage Vᵢₙ across the terminals, by switching the switch 36 so that the capacitor C1 is disconnected from the sensor strip Rₛₑₙₛ, the accuracy of the voltage Vᵢₙ across the terminals input to the comparator 40 can be increased. If there is no switch 36, an error, such as the voltage across the terminals of the sensor strip Rₛₑₙₛ, is included in the measured voltage Vᵢₙ across the terminals.

FIG. 5 illustrates an example of a connection location of a timer IC for controlling the switching of the multiplexers 24, 31, and 35 switches. As illustrated in FIG. 5, a timer IC 41 is connected between the output terminal 23b of the DC/DC converter 23 and a control terminal 24b of the multiplexer 24. Namely, the output terminal 23b of the DC/DC converter 23 and a terminal 41a of the timer IC 41 are connected, and the control terminal 24b of the multiplexer 24 and a terminal 41b of the timer IC 41 are connected. Further, the control terminals of the multiplexers 24, 31, and 35 are connected to each other. By configuring in this manner, the switching of the multiplexers 24, 31, and 35 switches can be controlled by the timer IC.

FIG. 6 illustrates a substrate detection device in which the display unit 29 is configured by a light-emitting diode (LED). As illustrated in FIG. 6, the anode of a light-emitting diode 42 is connected to the power supply line 27 via the current-limiting resistor R5, and the cathode of the light-emitting diode 42 is connected to the output terminal of the comparator 40. In this case, when the output of the comparator 40 is at a low level, current flows via the current-limiting resistor R5, and the light-emitting diode 42 is lit up. The accuracy of the voltage detection value can be changed by changing the voltage division ratio based on the fixed resistors R1 and R2.

Here, a supplementary description will be made regarding the DC/DC converter 30. The DC/DC converter 30 is a unit that converts an input voltage into an arbitrary voltage, and outputs the converted voltage. To enable this to occur, as illustrated in FIG. 7, in addition to the input terminal 30a into which a voltage Vᵢₙ′ is input and the output terminal 30b from which a voltage Vₒᵤₜ′ is output, the DC/DC converter 30 includes a feedback terminal 30c, into which a voltage obtained by dividing the output voltage Vₒᵤₜ′ with, for example, fixed resistors R10 and R11 connected in series is input. The DC/DC converter 30 includes a voltage supply that generates a reference voltage. In the DC/DC converter 30, the reference voltage generated by the included voltage supply and the voltage value obtained by dividing the output voltage value Vₒᵤₜ′ with the fixed resistors R10 and R11 are compared.

This relationship is represented by the following formula.

V_{FB}=Vₒᵤₜ′×R11/(R10+R11)

In this formula, R10 and R11 represent the resistance values of the fixed resistor R10 and the fixed resistor R11, respectively.

The DC/DC converter 30 performs the action reducing the conversion voltage when, for example, Vₒᵤₜ′ has increased for some reason, namely, when V_{FB}<Vₒᵤₜ′×R11/(R10+R11). In other words, it can be said that when a voltage greater than V_{FB} is applied to the feedback terminal 30c, the DC/DC converter 30 performs an operation for reducing the output voltage.

FIG. 8 illustrates a configuration example of the DC/DC converter 30. As illustrated in FIG. 8, the DC/DC converter 30 has a switching transistor 301 configured from a MOS transistor, an inductor 302, a regulator 303, an oscillator 304, and an error amplifier 305. The input voltage Vᵢₙ′ is supplied to the source of the switching transistor 301. The inductor 302 is connected to the drain of the switching transistor 301. The drain of the switching transistor 301 is grounded via a constant voltage diode 306. The regulator 303 is connected to the gate of the switching transistor 301. Further, the regulator 303 is connected to the output terminal of the oscillator 304 and the error amplifier 305, respectively. A reference voltage V_{ref}′ generated by a power supply 307 is input to the non-inverting input terminal of the error amplifier 305, and a voltage value obtained by dividing the output voltage value Vₒᵤₜ′ with the fixed resistor R10 and the fixed resistor R11 is input to the inverting input terminal.

The operation of the DC/DC converter 30 illustrated in FIG. 8 is as follows. The error amplifier 305 compares the voltage obtained by dividing the output voltage Vₒᵤₜ′ with the fixed resistor 10 and the fixed resistor 11 and the reference voltage V_{ref}′. Based on this comparison result, a PWM signal having a pulse width based on the input voltage Vᵢₙ′ is output and sent to the regulator 303. From the regulator 303, this PWM signal is input to the gate of the switching transistor 301. By driving the switching transistor 301 based on the PWM signal output to the gate in this manner, a lower voltage than the input voltage Vᵢₙ′ is generated as the output voltage Vₒᵤₜ′, and, a value for the output voltage Vₒᵤₜ′ is maintained in which the voltage obtained by dividing the output voltage Vₒᵤₜ′ with the fixed resistor R10 and the fixed resistor R11 and the reference voltage V_{ref}′ are equal to each other.

FIG. 9 illustrates an example of a PWM signal and a divided voltage. As illustrated in FIG. 9, when the output voltage Vₒᵤₜ′ is large, so consequently the divided voltage is large, the PWM signal has a small pulse width, and when the output voltage Vₒᵤₜ′ is small, so consequently the divided voltage is small, the PWM signal has a large pulse width. The reference voltage V_{ref}′ is a sawtooth wave.

FIG. 10 illustrates an equivalent circuit of the DC/DC converter 30 illustrated in FIG. 8. In FIG. 10, D represents a constant voltage diode, C represents a capacitor, and R represents a resistor. The above-described PWM signal is input to the gate to turn the switching transistor 301 ON/OFF. When the output voltage Vₒᵤₜ′ is small, the pulse width of the PWM signal increases, so that the operation increases the output voltage Vₒᵤₜ′. When the output voltage Vₒᵤₜ′ is large, the pulse width of the PWM signal decreases, so that the operation decreases the output voltage Vₒᵤₜ′.

FIG. 11 illustrates when the switching transistor 301 has been turned ON by the PWM signal. As illustrated in FIG. 11, at this stage, a current i flows through, in order, the switching transistor 301, the inductor 302, and the resistor R. In contrast, when the switching transistor 301 has been turned OFF by the PWM signal, as illustrated in FIG. 12, the current i flows through, in order, the inductor 302, the resistor R, and the constant voltage diode D.

As illustrated in FIG. 13, the capacitor C1 and a circuit in which the fixed resistor R4 and the sensor strip Rₛₑₙₛ are connected in parallel are connected in series to the output voltage Vₒᵤₜ′ output terminal of the DC/DC converter 30. Further, a midpoint between the capacitor C1 and the circuit in which the fixed resistor R4 and the sensor strip Rₛₑₙₛ are connected in parallel is connected to a feedback terminal of the DC/DC converter 30. Consequently, the terminal voltage of the circuit in which the fixed resistor R4 and the reference voltage V_{ref}′ are connected in parallel is compared with the reference voltage V_{ref}′ by the error amplifier 305. At this stage, the DC/DC converter 30 adjusts the output voltage Vₒᵤₜ′ so that the reference voltage V_{ref}′ and the terminal voltage of the circuit in which the fixed resistor R4 and the sensor strip 15 are connected in parallel are equal to each other.

Next, the relationship between the sensor current flowing from the sensor strip Rₛₑₙₛ and the voltage across the terminals of the capacitor C will be described. The sensor strip Rₛₑₙₛ oxidizes the substrate, which is the test target. By applying a constant voltage across the terminals of the sensor strip Rₛₑₙₛ, a flow of a current iₛ (sensor current) is generated by the electrons produced by oxidation. Further, the electrons produced by oxidation are stored in the capacitor C1. A charge amount Q that is stored in the capacitor C1 can be expressed as in formula (1) by integrating the current iₛ over time.

Q=∫₀tiₛdt (1)

Further, the voltage V_{c} across the terminals of the capacitor C1 and the accumulated charge amount Q have the relationship shown in formula (2).

V_{c}=Q/C (wherein C represents the electrostatic capacitance of the capacitor C1) (2)

Consequently, a voltage V_{c} is generated across the terminals of the capacitor C1.

Although a direct current does flow through the capacitor C1, a transient current can flow through. Consequently, after the constant current is applied to the sensor strip Rₛₑₙₛ, the relationship after to between the voltage V_{c} across the terminals of the capacitor C1 and the terminal voltage Vₛ of the sensor strip Rₛₑₙₛ is as illustrated in FIG. 14. In FIG. 14, V represents voltage and t represents time.

In FIG. 14, although the value of the current iₛ from the electrons produced from the sensor strip Rₛₑₙₛ is illustrated as being constant, since the charge amount Q that is stored in the capacitor C1 can be expressed by integrating the current iₛ over time, the voltage V_{c} across the terminals of the capacitor C1 can be obtained even if the current iₛ changes in a nonlinear manner. An example of this is illustrated in FIG. 15.

Formula (2) illustrates the fact that the voltage V_{c} across the terminals of the capacitor C1 can be expressed by the stored charge amount Q and the electrostatic capacitance C of the capacitor C1. Based on the magnitude of the electrostatic capacitance C of the capacitor C1, the rate of increase in the voltage V_{c} across the terminals of the capacitor C1 can be changed. An example of this is illustrated in FIG. 16.

The voltage value applied to the sensor strip Rₛₑₙₛ can be easily changed using a fixed resistor. FIG. 17 illustrates a portion of the circuit around the error amplifier 305 taken from the circuit illustrated in FIG. 13, in which the fixed resistor R3 has been added in series to the fixed resistor R4 in the circuit in which the fixed resistor R4 and the sensor strip Rₛₑₙₛ are connected in parallel. As already stated, the voltage value input to the feedback terminal of the error amplifier 305 is equal to the reference voltage V_{ref}′.

When the fixed resistor R3 is added, since the value obtained by dividing with the fixed resistor R3 and the fixed resistor R4 is input to the feedback terminal of the 305, the voltage value applied to the sensor strip Rₛₑₙₛ has a greater value than the reference voltage V_{ref}′. Namely:

Vₛ=(R3+R4)÷R4×V_{ref}′

Here, R3 and R4 represent the resistance value of the fixed resistor R3 and the fixed resistor R4. When R3=R4=1, from the above formula, Vₛ=2×V_{ref}′.

Next, the principles behind the improvement in the determination accuracy of the substrate concentration by employing a constant voltage using the DC/DC converter 30 will be described.

As illustrated in FIG. 18, when the DC/DC converter 30 is not used, and the capacitor C1 and the sensor strip Rₛₑₙₛ are connected in series, as charge accumulates in the capacitor C1, the voltage Vᵢₙ across the terminals increases, but the applied voltage Vₛₑₙₛ to the sensor strip Rₛₑₙₛ (=V_{DD}−Vᵢₙ) decreases. Therefore, the current I flowing to the sensor strip Rₛₑₙₛ decreases, and the rate of increase in Vᵢₙ is moderated. Further, the maximum value of Vᵢₙ becomes the applied voltage V_{DD}.

On the other hand, by employing a configuration like that illustrated in FIG. 19, which uses the DC/DC converter 30, the applied voltage Vₛₑₙₛ to the sensor strip Rₛₑₙₛ can be made constant. In addition, the maximum voltage of Vᵢₙ can be controlled by the DC/DC converter 30. Namely, by changing the output voltage of the DC/DC converter 30, Vᵢₙ can be changed while keeping Vₛₑₙₛ constant. Thus, the maximum allowable voltage becomes V_{DD}−Vₛₑₙₛ. Further, by providing the current limiting resistor R5 between the capacitor C1 and the sensor strip Rₛₑₙₛ, the rate of increase in Vᵢₙ can be controlled. Therefore, the higher the power supply voltage V_{DD}, the greater the width of the allowable voltage becomes, which enables the resolution performance of the substrate concentration to be improved.

FIG. 20 illustrates the change over time in the voltage Vᵢₙ across the terminals of the capacitor C1 when the substrate concentration is thick, namely, when (amount of electricity produced by oxidation of the substrate)+(amount of electricity from non-faradaic current)>CV_{DD} (wherein C represents the electrostatic capacitance of the capacitor C1) for cases in which there is no DC/DC converter 30, a case in which there is the DC/DC converter 30, and a case in which the current limiting resistor R5 is provided in addition to the DC/DC converter 30, respectively. As illustrated in FIG. 20, in the circuit illustrated in FIG. 18, in which the DC/DC converter 30 is not used, Vᵢₙ converges to V_{DD}. In contrast, in the circuit illustrated in FIG. 19, in which the DC/DC converter 30 is used, since the applied voltage Vₛₑₙₛ to the sensor strip Rₛₑₙₛ does not drop, the rise in Vᵢₙ is steeper than for the circuit illustrated in FIG. 18. In addition, as illustrated in FIG. 19, by either providing the current limiting resistor R5 or by increasing the electrostatic capacitance C of the capacitor C1, the rise in Vᵢₙ is moderated. The upper limit of Vᵢₙ becomes V_{DD}−Vₛₑₙₛ.

FIG. 21 illustrates the change over time in the voltage Vᵢₙ across the terminals of the capacitor C1 when the substrate concentration is thin, namely, when (amount of electricity produced by oxidation of the substrate)+(amount of electricity from non-faradaic current derived from electric double layer formation)<CV_{DD} for cases in which there is no DC/DC converter 30, a case in which there is the DC/DC converter 30, and a case in which the current limiting resistor R5 is provided in addition to the DC/DC converter 30, respectively. As illustrated in FIG. 21, in each of these cases, Vᵢₙ is maintained at V_{DD} or less.

In the substrate detection device illustrated in FIG. 2, although a single comparator 40 is used, the resolution performance of the substrate concentration can be adjusted by using a plurality of comparators. Namely, as illustrated in FIG. 22, a power supply line 27 and n-number (wherein n denotes an integer of 2 or more) of comparators P1 to Pn are provided between the operational amplifier 38 and the display unit 29. The power supply line 27 is grounded via n-number of fixed resistors R11 to R1n. The output of the operational amplifier 38 is input to the inverting input terminal of each of the comparators P1 to Pn. A voltage divided using the fixed resistors R11 to R1n is input as a reference voltage V1 to Vn to the non-inverting input terminal of each of the comparators P1 to Pn. In this substrate detection device illustrated in FIG. 22, the reference voltages V1 to Vn based on a predetermined substrate concentration and the voltage Vᵢₙ, across the terminals of the capacitor C1 can be compared by the comparators P1 to Pn, and the comparison result reflected on the display unit 29. By increasing the number of comparators P1 to Pn that are used, the resolution performance of the target substrate concentration can be freely adjusted. The resolution performance can also be adjusted by changing the output voltage of the DC/DC converter 30 and the voltage application time to the sensor strip Rₛₑₙₛ or the electrostatic capacitance C of the capacitor C1.

The input voltage to the non-inverting input terminal of each of the comparators P1 to Pn illustrated in FIG. 22 can be determined based on the following equations.

V1=V_{DD}×{(R2+R3+ . . . +Rn)/(R1+R2+R3+ . . . +Rn)}

V2=V_{DD}×{(R3+ . . . +Rn)/(R1+R2+R3+ . . . +Rn)}

Vn=V_{DD}×{(Rn)/(R1+R2+R3+ . . . +Rn)}

From the above, it can be seen that the input voltage value to the comparators P1 to Pn can be changed by setting the resistance value of the fixed resistors R1, R2, R3 . . . Rn for division at an arbitrary value. For example, if R1=R2= . . . Rn, the input voltage to the comparators P1 to Pn can be set at a value in which V_{DD} is divided equally. In addition, if the value of the divided-voltage resistance is selected so that R1 >>R2=R3= . . . Rn, the input voltage value to the comparators P1 to Pn can be set at a lower value than V_{DD}. Further, if R1=Rn>>R2=R3= . . . Rₙ₋₁, a voltage value centered around ½ V_{DD} can be set as the input voltage value to the comparators P1 to Pn.

Therefore, a more precise resolution performance can be obtained by arbitrarily selecting the division resistance value while also increasing the number n of comparators P1 to Pn.

Examples of this substrate detection device will now be described.

### Example 1

The substrate detection device illustrated in FIG. 6 was used as a glucose sensor. A TPS 62050 DGC was used for the DC/DC converters 23 and 30, a MAX 4734 was used for the multiplexers 24, 31, and 35, a MAX 4240 was used for the operational amplifier 38, and a MCP 6547 (microchip) was used for the comparator 40. For the sensor strip Rₛₑₙₛ, FAD- (flavin adenine dinucleotide-) dependent glucose dehydrogenase was used as the enzyme oxidizing the glucose serving as the substrate, and FS Blood Sugar Measurement Electrode Lite, manufactured by Abbott Japan, in which an osmium compound was immobilized, was used as the electron mediator.

To confirm operation of this substrate detection device as a glucose sensor, an experiment to measure the glucose concentration was carried out using glucose solutions having a known glucose concentration. Glucose solutions were prepared having a glucose concentration (expressed as “Glc”) of 0 mg/dL, 100 mg/dL, 200 mg/dL, and 300 mg/dL. The change over time from when the power supply voltage (V_{DD}) was applied in the voltage Vᵢₙ across the terminals of the capacitor C1, the applied voltage Vₛₑₙₛ of the sensor strip Rₛₑₙₛ, the input voltage of the comparator 40, the applied voltage of the light-emitting diode 42, and the 10× circuit current of the substrate detection device when the glucose concentration of these four kinds of glucose solution was measured is illustrated in FIGS. 23 to 26. From FIG. 23, it can be seen that for a Glc of 0 mg/dL, the light-emitting diode 42 was unlit for a period of about 7 seconds straight after the power supply voltage was applied, subsequently lit up until about the 22 second point, and then was unlit until about the 30 second point. From FIGS. 24 and 25, it can be seen that even for a Glc of 100 mg/dL and 200 mg/dL, the results were about the same as in FIG. 23. Further, from FIG. 26, it can be seen that for a Glc of 300 mg/dL, the light-emitting diode 42 was unlit for a period of about 8 seconds straight after the power supply voltage was applied, subsequently lit up until about the 27 second point, and then was unlit until about the 30 second point.

FIG. 27A is a bar graph illustrating the measurement result of the voltage Vᵢₙ across the terminals of the capacitor C1 when the light-emitting diode 42 started to light up and immediately before the light-emitting diode 42 was extinguished with respect to the glucose concentration of the glucose solution. Further, FIG. 27B is a graph illustrating the voltage drop while the light-emitting diode 42 is lit with respect to the glucose concentration of the glucose solution. Here, the voltage application time to the sensor strip Rₛₑₙₛ is 6 to 8 seconds, the applied voltage is 0.7 V, the lit up duration of the light-emitting diode 42 is 17 to 18 seconds, initial refers to immediately after the light-emitting diode 42 lit up, and final refers to immediately before the light-emitting diode was extinguished. For comparison, FIGS. 27A and 27B also show the same data for when a glucose solution having a Glc of 300 mg/dL was used in a case in which the multiplexer 36 was not provided in the circuit illustrated in FIG. 6. In FIG. 27A, 1.0 V is a high-medium threshold, and 0.7 V is a medium-low threshold. From FIG. 27B, it can be seen that when the multiplexer 36 is provided, the voltage drop while the light-emitting diode 42 is lit is about half that when the multiplexer 36 is not provided.

### Example 2

To confirm operation of the substrate detection device illustrated in FIGS. 19 and 20, an experiment to measure the glucose concentration was carried out using glucose solutions having a known glucose concentration. Here, in the sensor strip Rₛₑₙₛ, NAD⁺/NAD-dependent glucose dehydrogenase and diaphorase were immobilized as the enzyme oxidizing the glucose serving as the substrate.

Glucose solutions were prepared having a glucose concentration (expressed as “Glc”) of 0 mg/dL, 100 mg/dL, 200 mg/dL, and 300 mg/dL. The change over time from when the power supply voltage was applied in the voltage across the terminals of the capacitor C1 of the substrate detection device when the glucose concentration of these glucose solutions was measured is illustrated in FIG. 28. Here, V_{DD} is 0.7 V, V_{DD}′ is 2.85 V, C is 330 μF (wherein C represents the electrostatic capacitance of the capacitor C1), and R5<22 kΩ (wherein R5 denotes the resistance value of the fixed resistor R5).

This substrate detection device can be used to detect various kinds of substrate. Examples of the substrate may include, but are not limited to, glucose, bile acid, pyruvic acid, dissolved oxygen, formaldehyde, carbon monoxide and the like.

For example, a substrate detection device that detects glucose is a glucose sensor. A glucose sensor can be used as a urine sugar measurement device or a blood sugar self-monitoring device to diagnose diabetes, for example. The diagnostic criteria for diabetes is blood sugar level (any of a blood sugar level ≧126 mg/dL on an empty stomach, ≧200 mg/dL 2 hours after an OGTT, or ≧200 mg/dL normally). Here, OGTT is a test for determining diabetes based on the fluctuation in blood sugar level after drinking water in which 75 g of glucose is dissolved after fasting for not less than 10 hours.

A substrate detection device that detects bile acid is a bile acid sensor. A bile acid sensor can be used to diagnose disease of the hepatobiliary system. When enterohepatic circulation breaks down due to bile acid malabsorption or impaired excretion in the liver, bile acid leaks into the greater circulatory system, so that the bile acid concentration in the blood and the urine increases. FIG. 29 illustrates the principles for measuring bile acid (refer to Dictionary of Biosensors & Chemical Sensors, Technosystems, 2007). In FIG. 29, BSS represents bile acid sulfate sulfatase, B-HSD represents hydroxy steroid dehydrogenase, and NHO represents NADH oxidase.

A substrate detection device that detects pyruvic acid is a pyruvic acid sensor. Management of the concentration of pyruvic acid in Japanese sake mash is important in terms of determining the point to add alcohol. To prevent a costus-like odor, it is desirable to perform alcohol addition and lees separation after the pyruvic acid concentration has reached 1.14 mM (100 ppm) or less. Further, since the concentration of pyruvic acid during aging influences the odor of the sake, the pyruvic acid concentration in the mash is 0.23 to 11.36 mM (20 to 1,000 ppm), and the pyruvic acid concentration in the sake is 0.06 to 0.91 mM (5 to 80 ppm). FIG. 30 illustrates the principles for measuring pyruvic acid (refer to Dictionary of Biosensors & Chemical Sensors, Technosystems, 2007). In FIG. 30, POP represents pyruvic acid oxidase, FAD represents flavin adenine mononucleotide, and TPP represents thiamine pyrophosphate.

A substrate detection device that detects dissolved oxygen is a dissolved oxygen acid sensor. A BOD sensor rapidly measures BOD (biochemical oxygen demand), which is a representative index of water pollution. The greater the amount of organisms in the water, the lower the level of dissolved oxygen. In addition, in food industry processes and fermentation processes, various concentration measurements can be carried out with a Clark oxygen electrode that uses microorganisms which utilize organic matter, such as acetic acid, alcohol, formic acid, glutamic acid, methane and the like. FIG. 31 illustrates a polarograph type dissolved oxygen measurement apparatus. This polarograph type dissolved oxygen measurement apparatus is configured so that an electrolyte solution 52 is contained in a measurement tank 51. A diaphragm 53 that lets oxygen through but not the electrolyte solution 52 through is installed at the bottom face of the measurement tank 51. A work electrode 54 and a counter electrode 55 are arranged in the electrolyte solution 52. A power supply 56 and a capacitor 57 are connected across the work electrode 54 and the counter electrode 55. Current-voltage conversion is carried out by the capacitor 57. It is noted that the dissolved oxygen can also be detected using a microbial electrode.

A substrate detection device that detects formaldehyde is a formaldehyde sensor. Formaldehyde heads the list of substances that cause sickhouse syndrome. In the amended enforcement orders of the Japanese Building Health and Management Act that came into force in April, 2003, a standard is set at 0.08 ppm per cubic meter of air (100 μg/m³). In July 2003, the amended Building Standards Law came into effect, which limits the used surface area of building materials that give off large amounts of formaldehyde, and stipulates the installation of mechanical ventilator equipment. FIG. 32 illustrates an example of a formaldehyde sensor. As illustrated in FIG. 32, the formaldehyde sensor is configured so that an electrolyte solution 62 is contained in a measurement tank 61. A gas-permeable diaphragm 63 that lets formaldehyde through but not the electrolyte solution 62 through is installed on a side face of the measurement tank 61. A work electrode 64 and a counter electrode 65 are arranged in the electrolyte solution 62. A substrate detection device 66 is connected across the work electrode 64 and the counter electrode 65. A resistor 67 is connected between the substrate detection device 66 and the measurement tank 61. A gas inlet pipe 68 is attached to the gas-permeable diaphragm 63. A sample gas passes through the gas-permeable diaphragm 63 from this gas inlet pipe 68, and is introduced into the electrolyte solution 62. The gas in the electrolyte solution 62 is exhausted out of the system from the gas inlet pipe 68 attached to the gas-permeable diaphragm 63. The principles for measuring formaldehyde are as follows.

Work electrode: HCHO+H₂0→CO₂+4H+4e⁻

Counter electrode: O₂+4H⁺+4e⁻→2H₂O

A substrate detection device that detects carbon monoxide is a carbon monoxide sensor. A carbon monoxide sensor is effective in preventing accidents caused by poor air circulation, accidents caused by inflow of exhaust gases, accidents caused by a weapons equipment malfunction, and accidents caused by the failure to put out embers. The measurement principles are as follows.

Work electrode: CO+H₂0→CO₂+2H+2e⁻

Counter electrode: ½CO₂+2H⁺+2e⁻→H₂O

According to the first embodiment of the present disclosure, various advantageous effects such as the following can be obtained. Namely, since the voltage V_{cc} of the battery 21 is reduced by the DC/DC converters 23 and 30, which are Chopper-type voltage lowering circuits, and a sensor unit, namely, the sensor strip Rₛₑₙₛ, is connected to the feedback terminal 30c of the DC/DC converter 30, the voltage applied to the sensor strip Rₛₑₙₛ during measurement of the substrate concentration can be made constant. Further, the voltage applied to this sensor strip Rₛₑₙₛ can be arbitrarily set. In addition, the reference voltage V_{ref} that is based on a predetermined substrate concentration and the voltage across the terminals of the capacitor C1 can be compared by the comparator 40, and this result reflected on the display unit 29. Still further, the resolution performance of the target substrate concentration can be freely adjusted by selecting the number of comparators to be used. Moreover, the resolution performance can also be adjusted by changing the output voltage of the DC/DC converter 30 and the voltage application time to the sensor strip Rₛₑₙₛ or the electrostatic capacitance C of the capacitor C1. Further, leak current from the capacitor C1 can be suppressed, and consequently the input voltage to the comparator 40 can be maintained, by the operational amplifier 38 voltage follower and the multiplexers 24, 31, and 35. In addition, as illustrated in FIG. 5, the voltage application time to the sensor strip Rₛₑₙₛ and the input voltage to the display unit 29 can be controlled by the timer IC 41 and the multiplexers 24, 31, and 35. Still further, since this substrate detection device can be configured without having a calculation device such as a microcomputer, the circuit configuration can be simplified, so that lower power consumption and lower production costs can be achieved.

### 2. Second Embodiment of the Present Disclosure

### Biofuel Cell with a Substrate Detection Function

FIG. 33 illustrates a biofuel cell 70 with a substrate detection function according to a second embodiment of the present disclosure.

As illustrated in FIG. 33, this biofuel cell 70 with a substrate detection function is configured from a rectangular sheet-like battery unit 80 and a sheet-like sensor unit 90 integrally provided with the battery unit 80 on one side of the battery unit 80. The overall shape of biofuel cell 70 with a substrate detection function is like a sheet. The battery unit 80 has a fuel tank 81 that stores a fuel solution and battery electrode terminals 82. The sensor unit 90 has a substrate introduction port 91 and sensor electrode terminals 92. The battery unit 80 has a structure in which an electrolyte (proton conductor) is sandwiched between a positive electrode and a negative electrode that are formed from a porous material on which the respective appropriate enzyme is immobilized (e.g., JP 2000-133297A, JP 2003-282124, JP 2004-71559A, JP 2005-13210A, JP 2005-310613A, JP 2006-24555A, JP 2006-49215A, JP 2006-93090A, JP 2006-127957A, JP 2006-156354A, JP 2007-12281A, JP 2007-35437A, and JP 2011-222204A). The fuel solution stored in the fuel tank 81 passes through the battery unit 80, is introduced into the substrate introduction port 91 of the sensor unit 90, and the substrate concentration in the fuel solution is measured by the sensor unit 90. The sensor unit 90 has a part ot all of the same circuit as the substrate detection device according to the first embodiment of the present disclosure. Since this biofuel cell 70 with a substrate detection function can be configured inexpensively, it can also be used as a single-use (disposable) fuel cell as appropriate.

During use of this biofuel cell 70 with a substrate detection function, as illustrated in FIG. 34, the biofuel cell 70 with a substrate detection function is inserted from the battery electrode terminal 82 and sensor electrode terminal 92 side into a slot 102 provided on one face of a cuboid-shaped case 101. The case 101 is configured so that the terminals provided in the case 101 are in contact with and connected to the battery electrode terminals 82 of the battery unit 80 and the sensor electrode terminals 92 of the sensor unit 90 when the biofuel cell 70 with a substrate detection function is inserted. The case 101 has, for example, the display unit 29 of the substrate detection device according to the first embodiment of the present disclosure or a part of some other circuit.

FIG. 35 illustrates an example of the display unit of the case 101. As illustrated in FIG. 35, in this example, lamps 103 to 105 representing three levels, “low”, “normal”, and “high”, respectively, based on an arbitrarily set substrate concentration threshold are provided on an upper face of the case 101. For example, the lamp 103 may be a red lamp, the lamp 104 may be a white lamp, and the lamp 105 may be a blue lamp.

The method for supplying the fuel solution to the battery unit 80 is not especially limited, and may be selected as appropriate. For example, the method disclosed in JP 2011-22204A may be employed. An outline of this method will be described below. Since a biofuel cell starts to generate electricity as soon as fuel is supplied, it is desirable to separate the power generation unit and the fuel before use, and supply the fuel when the biofuel cell is to be used. Accordingly, JP 2011-22204A discloses a biofuel cell in which the power generation unit and the fuel tank are integrated, in which a separator is arranged between these two parts, and fuel is supplied by removing (folding or splitting) this separator when supplying fuel.

As illustrated in FIG. 36, the biofuel cell 201 with a substrate detection function may also be configured having a communication function, in which a display unit 29 displays a detection result of the substrate concentration by the biofuel cell 201 with a substrate detection function. Namely, a DC/DC converter 202 is connected to the output terminal of the biofuel cell 201 with a substrate detection function, which does not include the display unit 29. The DC/DC converter 202 is connected to a communication control device 203. Wireless communication can be performed by an antenna 204 connected to the communication control device 203. A serial communication device 205 is connected to the communication control device 203. By configuring in this manner, a measurement result of the substrate concentration by the sensor strip Rₛₑₙₛ can be transmitted to an information terminal, such as a personal computer (PC). The communication function can employ wireless communication, such as wireless LAN, Zigbee®, Wi-Fi, Bluetooth®, or a serial communication method, such as USB, RD-232C, and RS-422A, RD-485.

As illustrated in FIG. 37, a DC/DC converter 302 is connected to the output terminal of a biofuel cell 301 with a substrate detection function that does not include a display unit 29. The DC/DC converter 302 is connected to a measurement result storage device 303. The measurement result storage device 303 is connected to a storage device 304. By configuring in this manner, a measurement result of the substrate concentration by the sensor strip Rₛₑₙₛ can be stored in the storage device 304. As the storage device 304, a storage medium that includes a storage device such as an EEPROM or a removable storage medium may be used.

As illustrated in FIG. 38, by including a storage device in a biofuel cell 401 with a substrate detection function, measurement results about a measurement target (measurement specimen) and substrate concentration can be stored. In such a case, a non-volatile memory, a capacitor or the like may be used as the storage device. As such a storage device, a storage device produced by a printing process from a paste-like or ink-like organic material may be used as appropriate. In addition to a measurement result about the measurement target, the measurement results may also include information about the location or the date and time where the sample was acquired.

A fuel capsule may be used as the method for supplying fuel to the battery unit 80 of the biofuel cell 70 with a substrate detection function illustrated in FIG. 33.

The principles of a liquid fuel capsule will be described with reference to FIG. 39. As illustrated in FIG. 39A, a capsule 504 that encapsulates a liquid 502 with a film 503 is placed on a base 501. Thus, by forming the capsule 504 in which the liquid 502 is encapsulated by the film 503, the liquid 502 can be stably stored for a long period. Next, a container 505 is placed so as to cover the capsule 504. During usage of the capsule 504, the film 503 is broken by applying an external stimulus, such as physical pressure, light, temperature change, pH change and the like. Consequently, as illustrated in FIG. 39B, the capsule 504 bursts, and the internal liquid 502 flows out. Here, since the capsule 504 is covered with the container 505, the liquid 502 can be prevented from scattering when the film 503 is broken.

It is noted that, for example, in the container 505 illustrated in FIG. 39A, a different liquid (or a solid or a gas) may be arranged on the external side of the capsule 504, and mixed with the liquid 502 (or a solid or a gas) encapsulated by the film 503 by breaking the film 503 with an external stimulus during use of the capsule 504.

A method using such a capsule 504 of a liquid is applied in the supply of a fuel solution to the battery unit 80 of the biofuel cell 70 with a substrate detection function. Namely, a fuel capsule 604 that encapsulates a fuel solution 602 with a film 603 is placed on a negative electrode 601 of the battery unit 80. Thus, by forming the fuel capsule 604 in which the fuel solution 602 is encapsulated by the film 603, the fuel solution 602 can be stably stored for a long period. Next, a container 605 is placed so as to cover the fuel capsule 604. During usage of the fuel capsule 604, the film 603 is broken by applying an external stimulus, such as physical pressure, light, temperature change, pH change and the like, whereby fuel solution 602 inside the fuel capsule 604 flows out, and immerses the negative electrode 601. Here, since the fuel capsule 604 is covered with the container 605, the fuel solution 602 can be prevented from scattering when the film 603 is broken.

FIG. 34 illustrates an example in which, using the fuel capsule 604 as the fuel tank 81, the fuel capsule 604 is made to burst by pressing in the direction of the arrow in the diagram immediately before inserting the biofuel cell 70 with a substrate detection function into the slot 102, so that the fuel solution flows onto the negative electrode of the battery unit 80.

As illustrated in FIG. 41, a plurality of fuel capsules 604 may optionally be mounted in a two-dimensional array, for example, on the negative electrode 601, and the container 605 placed over each of the fuel capsules 604. By configuring in this manner, the amount of fuel solution 602 supplied to the negative electrode 601 can be substantially increased.

It should be understood by those skilled in the art that various modifications, combinations, sub-combinations and alterations may occur depending on design requirements and other factors insofar as they are within the scope of the appended claims or the equivalents thereof.

For example, the numerical values, structures, configurations, shapes, materials and the like mentioned in the above embodiments of the present disclosure and the working examples are merely examples which may be changed as appropriate to different numerical values, structures, configurations, shapes, materials and the like.

Additionally, the present application may also be configured as below.

(1) A substrate detection device including:

a sensor unit configured to extract electrons by oxidizing a substrate, the substrate being a test target;

a capacitor connected in series to the sensor unit; and

a circuit configured to measure a voltage across terminals of the capacitor,

wherein the substrate detection device determines a concentration of the substrate based on the voltage across the terminals of the capacitor.

(2) The substrate detection device according to (1), further including:

a power supply;

a constant voltage generation circuit supplied with a voltage from the power supply; and

a sensor unit constant voltage application circuit configured to apply a constant voltage generated by the constant voltage generation circuit to the sensor unit.

(3) The substrate detection device according to (1) or (2), further including at least one comparison circuit into which the voltage across the terminals of the capacitor is input.
(4) The substrate detection device according to any one of (1) to (3), further including:

an operational amplifier into which the voltage across the terminals of the capacitor is input,

wherein an output voltage of the operational amplifier is input to the comparison circuit and compared with a reference voltage.

(5) The substrate detection device according to any one of (2) to (4), wherein the constant voltage generation circuit has a first DC/DC converter configured to reduce the voltage of the power supply.
(6) The substrate detection device according to any one of (2) to (5),

wherein the sensor unit constant voltage application circuit has a second DC/DC converter that has a feedback terminal which reduces the voltage that was reduced by the first DC/DC converter, and

wherein the sensor unit is connected to the feedback terminal of the second DC/DC converter.

(7) The substrate detection device according to (6), wherein the sensor unit is connected to the feedback terminal of the second DC/DC converter via a fixed resistor.
(8) The substrate detection device according to any one of (3) to (7), further including a display unit supplied with an output voltage from the comparison circuit.
(9) The substrate detection device according to any one of (1) to (8), wherein the sensor unit includes an enzyme or a microorganism that oxidizes the substrate.
(10) The substrate detection device according to any one of (1) to (9), wherein the substrate is included in a liquid.
(11) The substrate detection device according to any one of (1) to (10), wherein the substrate is at least one kind selected from the group consisting of glucose, bile acid, pyruvic acid, dissolved oxygen, formaldehyde, and carbon monoxide.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A substrate detection device comprising:
a sensor unit configured to extract electrons by oxidizing a substrate, the substrate being a test target;
a capacitor connected in series to the sensor unit; and
a circuit configured to measure a voltage across terminals of the capacitor,
wherein the substrate detection device determines a concentration of the substrate based on the voltage across the terminals of the capacitor.

2. The substrate detection device according to claim 1, further comprising:
a power supply;
a constant voltage generation circuit supplied with a voltage from the power supply; and
a sensor unit constant voltage application circuit configured to apply a constant voltage generated by the constant voltage generation circuit to the sensor unit.

3. The substrate detection device according to claim 2, further comprising at least one comparison circuit into which the voltage across the terminals of the capacitor is input.

4. The substrate detection device according to claim 3, further comprising:
an operational amplifier into which the voltage across the terminals of the capacitor is input,
wherein an output voltage of the operational amplifier is input to the comparison circuit and compared with a reference voltage.

5. The substrate detection device according to claim 4, wherein the constant voltage generation circuit has a first DC/DC converter configured to reduce the voltage of the power supply.

6. The substrate detection device according to claim 5,
wherein the sensor unit constant voltage application circuit has a second DC/DC converter that has a feedback terminal which reduces the voltage that was reduced by the first DC/DC converter, and
wherein the sensor unit is connected to the feedback terminal of the second DC/DC converter.

7. The substrate detection device according to claim 6, wherein the sensor unit is connected to the feedback terminal of the second DC/DC converter via a fixed resistor.

8. The substrate detection device according to claim 7, further comprising a display unit supplied with an output voltage from the comparison circuit.

9. The substrate detection device according to claim 8, wherein the sensor unit includes an enzyme or a microorganism that oxidizes the substrate.

10. The substrate detection device according to claim 9, wherein the substrate is included in a liquid.

11. The substrate detection device according to claim 10, wherein the substrate is at least one kind selected from the group consisting of glucose, bile acid, pyruvic acid, dissolved oxygen, formaldehyde, and carbon monoxide.

12. A biofuel cell with a substrate detection function, comprising:
a biofuel cell configured to generate electricity by extracting electrons by oxidizing a substrate included in a fuel solution; and
a substrate detection device integrally provided with the biofuel cell,
wherein the substrate detection device includes
a sensor unit configured to extract electrons by oxidizing a substrate, the substrate being a test target,
a capacitor connected in series to the sensor unit, and
a circuit configured to measure a voltage across terminals of the capacitor, and
wherein the substrate detection device determines a concentration of the substrate based on the voltage across the terminals of the capacitor.
